(19) United States
(12) Patent Application Publication
(10) Pub. No.: US 2009/0113619 A1
(43) Pub. Date: May 7, 2009

(54) Dual spout-type faucet with controllable conventional-flow and mister-flow rates

(76) Inventors: Clyde L. Tichenor, Somis, CA (US); Darrell Jay Metcalf, Fillmore, CA (US)

Correspondence Address: Clyde L. Tichenor, P.O. BOX 734, Somis, CA, 93066, US

(21) Appl. No.: 12/290,788

(22) Filed: Nov. 4, 2008

Related U.S. Application Data
(60) Provisional application No. 61/001,669, filed on Nov. 5, 2007.

(51) Int. Cl. E03C 1/00; E03B 11/02; B05B 15/06

(52) U.S. Cl. 4/650; 137/801; 4/619; 137/565.01; 239/200

(57) ABSTRACT

A dual spout-type faucet with controllable conventional-flow and mister-flow rates is provided. In a first mode, one or more mister elements, or apertures having mister-like openings, are co-located proximate to a spout outlet, wherein water flow rates to the mister elements (or openings) and spout outlet are both controllable by one or more valve controllers accessible to a user. In a second mode, one or more mister elements, or apertures having mister-like openings, are co-axially located in a spout outlet wherein water flow rates to the mister elements (or openings) and spout outlet are both controllable by one or more valve controllers accessible to a user. In another embodiment the apparatus may be handheld and positionable and equipped to dispense soap or a cleaning solution optionally including attachable scrubbers.

### CROSS-REFERENCE TO RELATED APPLICATION

This application is a Non-Provisional Application which relies substantially on U.S. Provisional Patent Application Ser. No. 61/001,669 filed on Oct. 31, 2007, the disclosures of both of which are hereby incorporated by reference as if fully set forth herein.

### FIELD OF THE INVENTION

The present invention pertains to the field of water-conserving apparatus and systems. More particularly it relates valve controllable water faucets equipped with one or more misters or mister nozzles and one/or more optional streaming-water flow outlets.

### BACKGROUND OF THE INVENTION

As populations around the world, including in urban and suburban areas, continue to grow, so too does the need to provide such populations with an adequate supply of water. Some forecasts now suggest that water will become an increasingly precious commodity in certain areas of the world, such as regions located in drier climates.

An additional concern relating to water is the power or energy resources needed to pump and/or transport it from one or more places to another, including doing so from ground level water sources to the many floors of high-rise buildings. Processing waste water also requires energy. Thus, the more water that needs to be pumped, delivered, disposed of or processed, the more energy is required, with consequent environmental impact.

To date, little has been done to effectively reduce water usage with faucets. Some have been fitted with lower water flow-rate spouts providing a reduced stream of water, however such approaches fall far short of obtaining substantial faucet water usage reductions that are possible. Accordingly, a lot more energy resources continue to be used to provide water to faucet-equipped plumbing apparatus and such status quo approaches continue to waste a lot more water than often is necessary.

One area where faucet water usage can substantially be reduced is in the washing and/or rinsing of hands, such as in a lavatory or at a sink. In typical status quo approaches one turns on a faucet and, while the water is running, applies a volume of soap to one's hands rubbing them together under a stream of water that can be emitted from a faucet under 50-70 PSI pressure. The stream of water continues until one has adequately removed the soap from their hands. Another area where water usage can substantially be reduced is in the washing and/or rinsing of produce such as fruits or vegetables. For example during the preparation of a meal at a kitchen sink. In typical status quo approaches one turns on a faucet valve (or a motion-detection device does so) and while the water is running, employs a soap dispenser to apply a volume of soap to the produce rubbing it under a stream of water which continues until all soap has adequately been removed from produce. In each case, a good deal of the water consumed in these washing and/or rinsing procedures (even without soaping) simply flows past one's hands or the produce wasting the excess water.

Additional water usage and unnecessary added material costs are also a consequence of the typical fast streaming water-flow of conventional faucets, which often create a lateral splashing of water occurring when a streaming water-flow is directed onto one or more hands or items being washed or rinsed, and thereby requiring larger water capture apparatus (and associate cost) to accommodate such lateral splashing.

Accordingly there is a need to reduce or eliminate the amount of water wasted in such procedures and to provide a new type of faucet which provides a water volume in the minimal range required to effectively accomplish the aforementioned washing and rinsing procedures while also substantially reducing or eliminating lateral splashing and the need for water capture apparatus sized larger to accommodate such splashing.

While in some instances it can be advantageous to employ a faucet which provides a conventional stream of water, it is difficult to reduce water flow to a minimal level which is also useful e.g., when the water emitted from the faucet goes from a stream to a dribble, with the latter providing poor hand or produce washing or rinsing coverage. Thus there is a need to provide a minimal water flow rate emitted from the underside of a faucet. There is also need to provide effective coverage of a minimal water flow over a surface of one or more hands or items needing to be washed or rinsed.

### SUMMARY OF THE INVENTION

The aforementioned deficiencies and disadvantages are addressed and overcome by the present low water-flow, mister-equipped faucet, and water capture system which comprises mounting, integrally forming, fabricating or otherwise equipping one or more misters or mister nozzles to an underside portion of a faucet so as to direct a mist-cone of water (or other three-dimensionally shaped water-mist) from the mister(s) through a washing and/or rinsing mist-emitting range into water capture and drainage apparatus.

In one embodiment, an underside portion of a faucet, such as any among a broad variety of faucet designs, is equipped, fitted, fabricated, or integrally formed with, at least one mister or mister nozzle so as to direct a mist-cone of (or other three-dimensionally shaped) water into water capture and drainage apparatus, providing a washing and/or rinsing zone between mist-cone or other water shape. In another embodiment a faucet or water conduit attachable and removable spout-end equipped with at least one mister or mister nozzle having an upper threaded end is attachable or retro-fittable to and removable from the faucet water outlet end of any among a wide variety of faucet designs, wherein attaching the mister-equipped spout-end is achieved by screwing the threaded spout-end onto a threaded portion of the faucet end, and removing the spout-end is achieved by unscrewing it. In a variant of this latter embodiment the end of a water conduit which is generally directed downward toward water capture and drainage apparatus can simply be fitted with a mister or mister nozzle and apparatus for controlling the water, or water flow rate to the mister, whereby such combination of elements serve as a faucet. In the aforementioned embodiments a faucet can additionally be equipped with (i.) both the one or more misters or mister nozzles, (ii.) a streaming water-flow outlet, and (iii.) one or more controllable valves to control the water flow or water flow rate to the mister(s), or the streaming water-flow outlet, or both. For example, one or more misters can be co-located within a fixed, attachable or retro-fittable spout-end of a faucet, or a single mister can be co-axially mounted within the spout-end, with the spout-end also including one or more streaming water-flow apertures sized to emit a streaming flow of water similar to, or up to, that of conventional faucets, such that a mist-cone or other three-dimensionally-shaped water is emitted from the spout-end mister(s) when water is directed to it by a controllable valve, and a streaming water-flow is emitted from the spout-end aperture(s) when water is directed to it by a controllable valve, and optionally wherein water is directed to both by a controllable valve. In another embodiment, one or more misters can be located proximate to a spout-end of a faucet such that a mist-cone or other three-dimensionally shaped water is directed into the same water capture and drainage apparatus as a streaming flow of water when the latter is emitted from the spout-end of the faucet, wherein either, or both types of water outlets are controllable in a manner previously described.

It is noted that the present washing and/or rinsing water-conserving system can employ any in a variety of manually, mechanically or electro-mechanically controllable valves or pumps, including those which are controllable in response to motion-detection electronics which sense a user within a predetermined range.

It is noted that the present mister-equipped faucet and water capture system preferably employs one or misters or mister nozzles which emit a non-splashing type of mist which in turn allows for the use of water capture and/or drainage apparatus having a reduced-size, in contrast to faucets providing a conventional streaming water-flow which produces a lateral splashing effect when the water is directed onto one or more items, the latter thereby requiring larger (more costly) water capture and drainage apparatus.

### BRIEF DESCRIPTION OF THE DRAWINGS

FIG. 1 is a side view depiction of an embodiment of the invention comprising a faucet having a water outlet consisting of a mister (or mister nozzle) mounted adjacent to a spout-end of the faucet such that a mist-cone of water when emitted from the mister is directed over a mist emitting range, sufficient to accommodate one or two hands of a user, into water capture and drainage apparatus. Optional motion-detection apparatus is depicted beneath the faucet.

FIGS. 2A and 2B are partial side and bottom views respectively, of an end of the faucet depicted in FIG. 1. In the partial bottom view of FIG. 2B the lower end of the faucet spout is shown having a mister as a faucet water outlet.

FIGS. 3A and 3B are partial side and bottom views respectively, and similar to the end of the faucet depicted in FIG. 1, wherein the end of the faucet spout is shown having a mister as a low water-flow faucet water outlet which is co-located within a streaming water-flow aperture.

FIGS. 4A and 4B are partial side and bottom views respectively, and similar to the end of the faucet depicted in FIGS. 3A and 3B, wherein the faucet end further comprises a user-controllable valve whereby a user can selectively determine a water flow rate through one or more streaming water-flow aperture(s) or the mister by rotating a valve member.

FIGS. 5A and 5C are bottom views of the faucet spout-end and valve depicted in FIG. 4B. In FIG. 5A a positionable valve member having streaming water flow apertures shown in dashed lines is depicted having been rotated by a user positionable lever to a closed position. In FIG. 5C the apertures of the positionable valve member have been rotated by the user positionable lever to an opened position, so as to be in registration with fixed apertures of the faucet spout-end. FIGS. 5B and 5D are side view representations of FIGS. 5A and 5C respectively, wherein in FIG. 5B an upper rotatable valve member is in a closed valve position and in FIG. 5D the upper rotatable valve member is in an opened valve position.

FIGS. 6A and 6B are partial side and bottom views respectively, and similar to the end of the faucet depicted in FIGS. 4A and 4B, wherein the faucet further comprises a mister mounted on its underside, and a user-controllable valve interposed between the mister and the spout-end is employable by a user to selectively determine a water flow rate through one or more streaming water-flow aperture(s) of the spout end, or the mister.

FIGS. 7 and 8 are side view depictions, wherein an attachable valve-controllable faucet is shown mounted to the end of a pipe-mounted faucet, and comprises a mister mounted on the underside of the valve-controllable faucet and a user-controllable valve interposed between the mister and the spout-end employable by a user to selectively determine a water flow rate through one or more streaming water-flow aperture(s) of the spout end, or the mister. The two figures further depict the locating of water capture and drainage apparatus positioned beneath the water stream of FIG. 7 and the mist emitted from the mister of FIG. 8.

FIG. 9 is a cross-sectional side view depiction of a removably attachable spout-end equipped with a mister nozzle and an optional removable filter element. The spout-end is further depicted having threading located on an upper outer diameter suitable for screwing the spout-end into the threaded inner diameter end of a faucet.

FIG. 10 is a cross-sectional side view depiction similar to FIG. 9 further comprising the spout-end having a rotatable valve member which when rotated to a first position (as depicted) prevents a streaming water-flow from the spout-end and directs water only through the mister, and when rotated to a second position allows a streaming water-flow from the spout-end and through the mister. Optionally the spout-end can be equipped with threading located on an upper outer diameter suitable for screwing the spout-end into the threaded inner diameter end of a faucet.

FIGS. 11A and 11B are cross-sectional side view depictions of a removably attachable spout-end equipped with a mister nozzle and an optional removable filter element. The spout-end is depicted further comprising a transverse rotatable dual valve, wherein the valve when rotated to a first position (as in FIG. 11A) prevents a streaming water-flow from the spout-end and directs water only through the mister, and when rotated to a second position (as in FIG. 11B) allows a streaming water-flow from the spout-end and prevents water from being directed through the mister. Optionally an in-between setting of the transverse rotatable dual valve can provide for the flow of water through both the streaming water aperture(s) and mister of the spout-end.

FIGS. 12A and 12B are cross-sectional side view depictions similar to FIGS. 11A and 11B. The spout-end is depicted further comprising a transverse rotatable camshaft, wherein the camshaft when rotated to a first position (as in FIG. 12A) prevents water from being directed through the mister and directs a streaming water-flow from the spout-end and water only through the a streaming water-flow from the spout-end mister, and when rotated to a second position (as in FIG. 12B) directs water through the mister and prevents a streaming water-flow from the spout-end. Optionally an in-between setting of the transverse rotatable camshaft can provide for the flow of water through both the streaming water aperture(s) and mister of the spout-end.

FIGS. 13A and 13B are cross-sectional side view depictions comprising a transverse rotatable dual valve and mister, wherein the valve/mister combination when rotated to a first position (as in FIG. 13A) allows a streaming water-flow from the spout-end and prevents water from being directed through the mister, and when rotated to a second position (as in FIG. 13B) prevents a streaming water-flow from the spout-end and directs water only through the mister. Optionally an in-between setting of the transverse rotatable dual valve and mister can provide for the controlling of the flow of water through both the streaming water aperture(s) and mister of the spout-end.

FIGS. 14A and 14B are two-dimensional depictions of a handheld positionable dual-spout (with mister), shown in a bottom view in FIG. 14A and in a side view in FIG. 14B, having apparatus for controlling the rate, or ratio, of water between a double-spout having one or more misters (a first spout-type) co-axially located within, or proximate to, a spout configured for conventional water flow-rates (a first spout-type).

FIGS. 15A through 15C are each two-dimensional depictions of side views of releasably-attachable spout-end scrubber elements, wherein FIG. 15A depicts a scrubber having different brush bristle lengths, FIG. 15B depicts a scrubber having shorter brush bristles, and FIG. 15C depicts a scrubber having different brush bristles or bristle-density (i.e. less bristles)

### PREFERRED EMBODIMENTS OF THE INVENTION

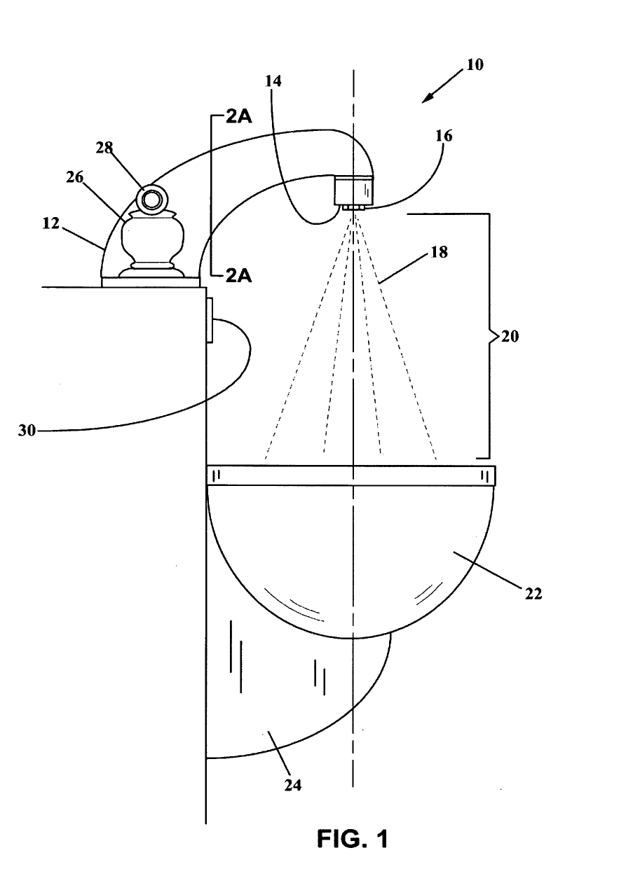

In reference to FIG. 1 a side view of a low water-flow faucet and drainage system 10 is depicted, comprising a faucet 12 having a mister 16 (or one or more misters or mister nozzles) mounted to the underside of the faucet preferably at a spout-end 14. Optionally the faucet 12 includes at least one user-controllable valve 26 having a valve controller 28, such as a valve handle 28 or lever by which the flow of water of the faucet can be controlled. Alternatively, water flow can be controlled by electromechanical apparatus, such as motion detection device 30, or a user-activated switch which activates a pump and/or valve, optionally doing so for a predetermined length of time and/or at a predetermined water flow-rate, or for a predetermined water volume, or at a predetermined pressure (or within a pressure range), or any combination thereof. For example, the system can include one or more misters having a water flow-rate in the range of 3-6 ounces of water per minute and optionally include a timing device which shuts off water after a predetermined length of time (such as one minute or two).

Additionally the system can include a water conduit, receptacle or standpipe (preferably located proximate to a faucet of the system) which is sized to contain a predetermined volume of water suitable to complete a single washing and/or rinsing cycle. Optionally, the water conduit receptacle or standpipe (hereinafter referred to as “conduit”) can additionally include a volume of air which becomes pressurized as water-volume control means (such as float valve or shut-off valve) receives a replenishing volume of water into the conduit, such that upon the initiating of a subsequent wash/rinse cycle the pressurized air causes the predetermined volume of water to be emitted from a system-faucet's one or more misters, or streaming water-flow aperture(s), or both.

Additionally or alternatively the system can include a water conduit or receptacle which is sized to contain a predetermined volume of water suitable to complete a single washing and/or rinsing cycle and which is pressurized by a force applied by one or more portions of a user's body, such as the user applying a pushing or pulling movement to a hand or foot operated pump or pump member (e.g., by doing so with one or two hands or feet), or by the user partially or entirely standing on a moveable member such as a plate, platform or pad which converts user-weight into a movement which is transferred by suitable linkage or coupling to a pump.

Preferably a momentary water valve opening to replenish the aforementioned predetermined volume of water, occurs immediately after, or subsequent to a predetermined or adjustable timed delay (e.g., responsive to a mechanical or electronic timer) after, each partial or total pumping of the predetermined volume of water.

When water flow is turned on, for example by any of the aforementioned methods, a mist-cone of water 18 (or other mister-emitted water shape) is emitted from the mister(s) mounted on the underside of the faucet 12 over a mist-emitting range 20 into a water capture and drainage apparatus 22. Preferably the mist-emitting range 20 is dimensioned so as to accommodate a user inserting and washing and/or rinsing one or two hands (or other item) into the mist-cone of water 18 in a non-splashing manner with a water capture and drainage apparatus 22 located beneath the mister(s) sized and shaped so as to capture all (or most) of the emitted water. For example, the emitted mist can be in a controlled water-flow range which causes the water mist to generally flow about and collect on a washed item without, or with substantially reduced, lateral splashing. Similarly, embodiments of the system described herein which also accommodate one or more streaming water-flow outlets can include a controlled water-flow range which minimizes or significantly reduces lateral water splashing. In case, reduced sized water capture and drainage apparatus are possible because the system does not have to accommodate lateral splashing water. Accordingly, such embodiments can optionally be made smaller than typical faucet and water capture apparatus and thereby provide a savings in material and associated costs.

For purposes of illustration, the water capture and drainage apparatus 22 of FIG. 1 is depicted as a bowl-shaped device which preferably includes drainage plumbing 24 for directing waste water away from the bottom of the apparatus (for example, to a sewer pipe or waste water storage system). However, it is noted that the use of any in a variety of other water capture and drainage apparatus 22 is also possible and can alternatively be employed.

For example, in an embodiment of the system at a campsite, or in a remote area, a water capture and drainage apparatus 22 can comprise a drainage grate or bed of small rocks with the grate or bed-area sized and shaped, and co-axially located beneath a mister 16 of a faucet 12, such that all (or most) of the emitted water from the faucet is readily directed into the grate or bed of rocks, and an emitted cone of water descends over a mist-emitting range 20 which accommodates a user washing and/or rinsing his or her hands (or other item) in the water before it descends to the grate or bed of small rocks (or pebbles). It is also noted that such faucet systems can be mounted at or fastened to an end of a supported or free-standing pipe.

Preferably a soap dispenser with quick-rinse soap is located proximate to any of the faucets 12 of the system (not shown) whereby a user can dispense soap of a type requiring minimal water usage (e.g., an alcohol-based soap). Preferably the quick-rinse soap is also of a type which is biodegradable and/or of a type having minimal effect on the environment.

Due to the very low volume of water used during each user washing and/or rinsing cycle of the present system it is also possible, such as in the use of mobile washing units, or in areas wherein waste water cannot be drained, to couple waste water output of the system to one or more receptacles to facilitate storage, transport or processing and/or re-cycling of all or most of the waste water.

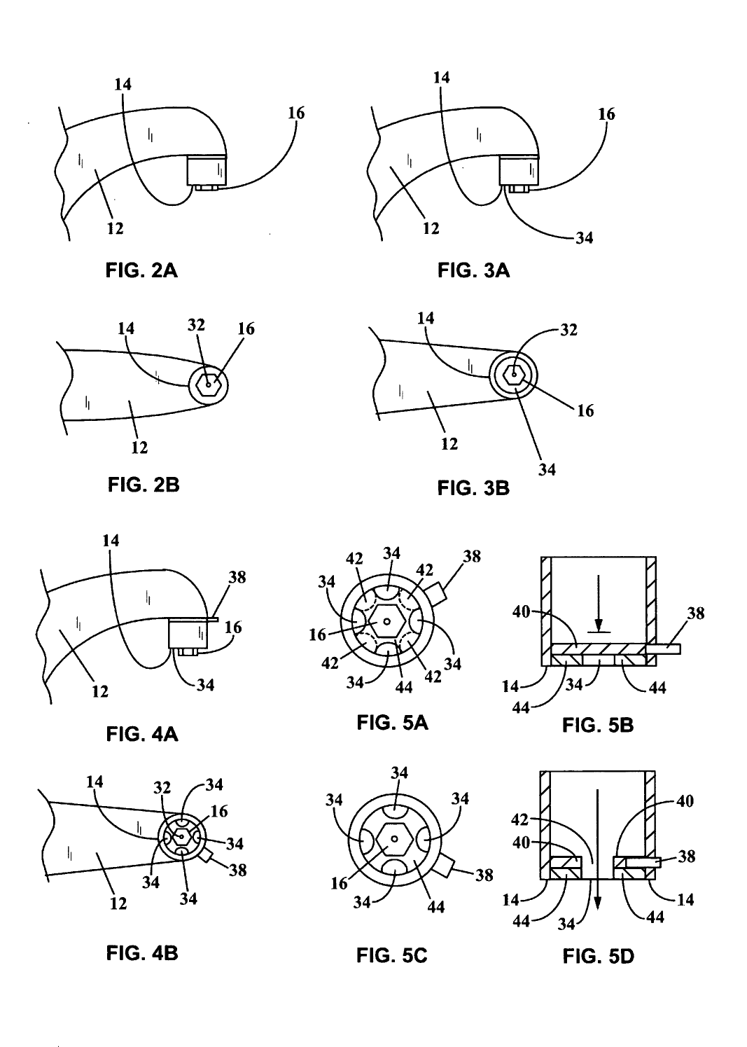

FIGS. 2A and 2B are partial side and bottom views respectively of an end of the faucet 12 depicted in FIG. 1. In the partial bottom view of FIG. 2B the lower end of the faucet spout-end 14 is shown having a mister 16 and at least one mister aperture 32 which functions as a very low water flow-rate faucet water outlet. Alternatively, spout-end 14 can be fitted with a plurality of misters, or other nozzle(s) which emit a three dimensionally shaped mist of water (not shown). It is noted that while the misters in FIGS. 2A, 2B, 3A, 3B 4A, 4B 5A, 5B, 6A, 6B and 11A through 13B are depicted having a hexagonally shaped end, that the system can readily accommodate the use of misters, nozzles or mister-nozzles having any among a variety of other commercially available or custom designed shapes.

FIGS. 3A and 3B are partial side and bottom views respectively, similar to the end of the faucet end depicted in FIG. 1 and FIGS. 2A and 2B, wherein the faucet spout-end 14 is equipped with a mister 16 as a mist-emitting faucet water outlet which is co-located within, co-axially located within, or substantially surrounded by, a high water-flow aperture 34. In the embodiments of the present system having one or more co-located misters within a spout-end, water flow can be directed to the mister aperture(s) 32, or to one or more high water-flow aperture(s) 34, or in a fixed or adjustable ratio to both (32 and 34) by a controlling of one or more valves preceding either or both types of apertures (e.g., see FIGS. 4A, 4B, 5A, 5B, 6A and 6B). For example, a faucet 12 having an underside mounted mister co-axially located above water capture and drainage apparatus 22 (such as a sink and/or sink drain) can be equipped with one or more standard valves for controlling the flow of cold and/or hot water through one or more high water-flow aperture(s) 34, and one or more separate valves for controlling the flow of cold and/or hot water through the mister aperture(s) 32. Preferably the controllable water flow rate to the one or more high water-flow aperture(s) 34 is in the water flow range of a typical sink faucet. Alternatively, the mister-equipped faucet system can be equipped with two typical-looking faucet valves, one for controlling the flow of water through one or more high water-flow aperture(s) 34, and one for controlling the flow of water through the mister aperture(s) 32. Thus, a faucet of the present system can have the same general appearance as any among a variety of commercially sold faucets.

Alternatively, one or more valves of the system can be electro-mechanically operated, such as valves controlled by the system having an electronic circuit which includes any in a variety of motion detection components, whereby the system-faucet responds to the detection of the movement of a proximate user e.g., by turning on one or more valves for a predetermined duration and/or for emitting a predetermined volume of water. Preferably the system includes the option to locate such electro-mechanically operated means so that they are partially or entirely hidden from sight.

Thus with the present faucet water-conserving system, a number of valve arrangements, whether manually operated or electro-mechanically implemented, are possible for controlling the water flow volume and/or rate to one or more streaming water-flow apertures, or one or more mist-emitting apertures, or in a fixed or adjustable ratio to both. To illustrate some of the possibilities, several examples will be described in reference to FIGS. 4A through 13B.

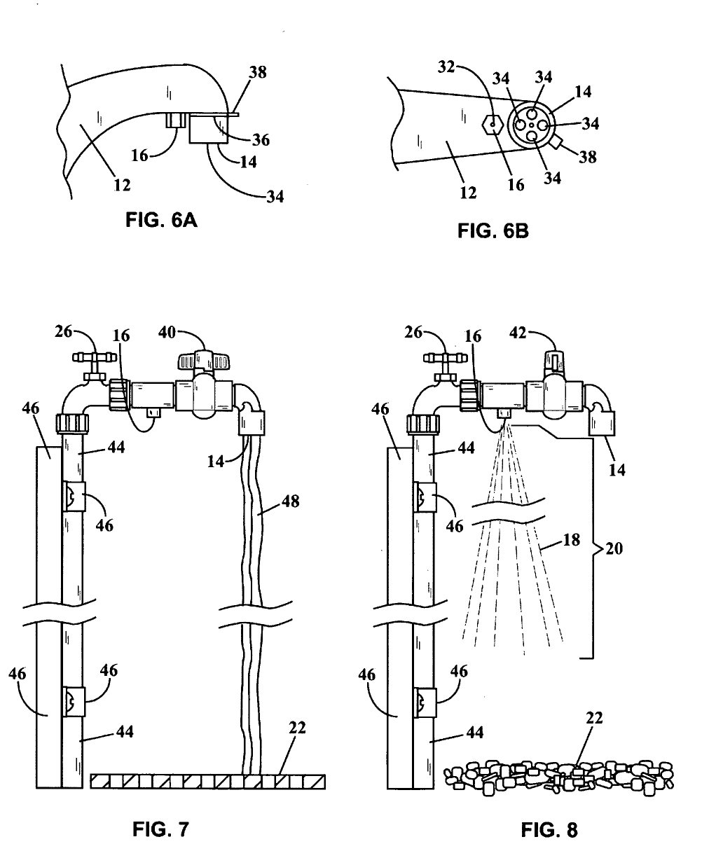

In reference to FIGS. 4A and 4B partial side and bottom views are depicted respectively, similar to the end of the faucet depicted in FIGS. 3A and 3B, wherein the faucet-end 14 further comprises a user-controllable valve whereby a user can selectively determine a water flow rate through one or more streaming water-flow aperture(s) 34 or mister aperture(s) 32 by rotating a valve member. FIGS. 5A and 5C are bottom detailed depictions of the faucet spout-end 14 and valve depicted in FIG. 4B. In FIG. 5A a rotatably positionable apertured valve member 40 having valve member apertures 42 (shown in dashed lines) for directing a streaming water flow, is depicted having been rotated by a user positionable lever (valve controller 38) to a closed position wherein apertures 42 are rotated out of registration with streaming water-flow apertures 34 of spout-end 14. In FIG. 5C the apertures of the positionable apertured valve member 40 have been rotated by the user positionable lever to an opened position, so as to be in registration with streaming water-flow apertures 34 of the faucet spout-end 14. FIGS. 5B and 5D are side view representations of FIGS. 5A and 5C respectively, wherein in FIG. 5B an upper rotatably positionable apertured valve member 40 is depicted having been rotated into a closed valve position such that its valve member apertures 42 are not in registration with the apertures 34 thereby preventing the spout-end 14 to emit a streaming water-flow (as indicated by the vertical downward pointing arrow stopping at a lower horizontal line). In FIG. 5D the upper rotatable valve member 40 is depicted having been rotated into an opened valve position such that its valve member apertures 42 are in registration with the apertures 34 of the spout-end 14 thereby permitting the spout-end to emit a streaming water-flow (as indicated by the vertical downward pointing arrow). FIGS. 6A and 6B are partial side and bottom views respectively, similar to the end of the faucet depicted in FIGS. 4A and 4B, wherein the faucet also comprises a mister mounted on its underside which is proximate to and not co-located within the spout-end 14, and a user-controllable valve interposed between the mister 16 and the spout-end 14 is employable by a user as previously described to selectively determine a water flow rate through one or more streaming water-flow aperture(s) of the spout-end 14, or the mister 16 (or mister nozzle). Preferably one or more spout-end proximate misters 16 or mister nozzles employable in the latter embodiment of the system are selected from among a group of misters requiring water above a PSI threshold which is not attained when the valve (such as rotatable valve 36) interposed between the spout-end 14 and the mister(s) 16 is opened (to emit a streaming water-flow), but is attained when the valve (36) is closed. For example, a mister can be employed that requires >15 PSI of water which is not attained when valve 36 is opened but is readily attained when the valve is closed.

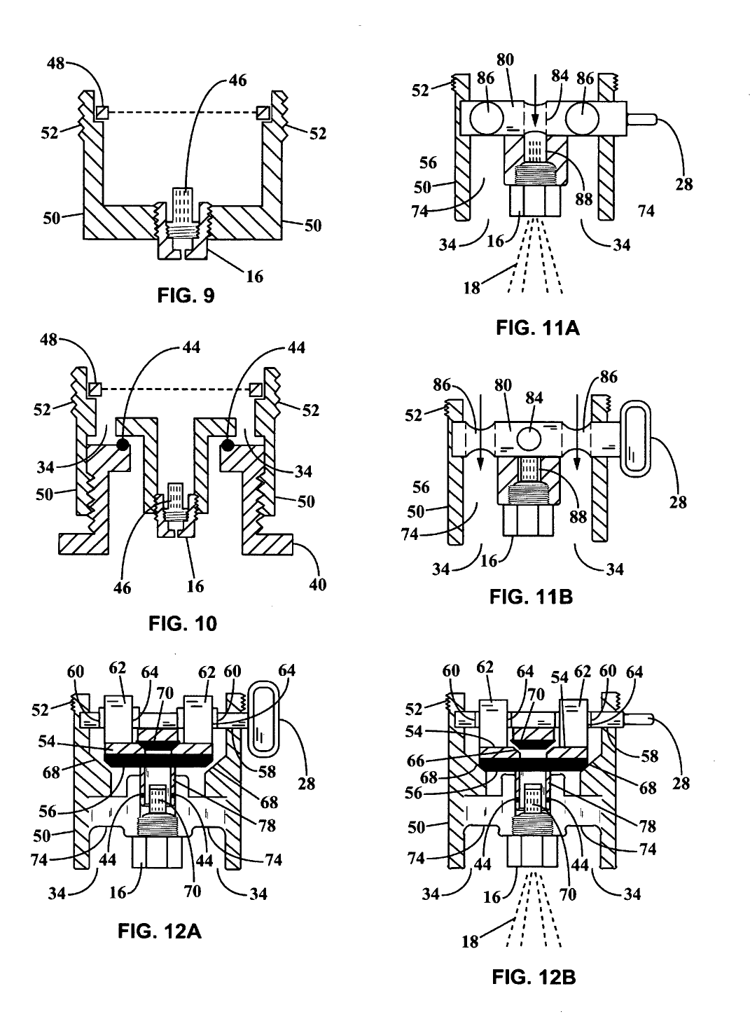

As previously mentioned, a spout-end 14 can be integrally formed in the making of a faucet 12 of the present low water-flow faucet and drainage system 10, or alternatively, a commercially-available faucet having an internally or externally threaded end can be fitted or retro-fitted with a threaded spout-end 14 of the system. For example, spout-end 14 of FIGS. 1, 2A, 2B, 3A, 3B, 4A, 4B, 5A, 5C, 6A, 6B, 9, 10, 11A, 11B, 12A and 12B can be made with male threads 52 (see FIGS. 9 through 12B) which can be screwed into female threads (or standardized threads) located in the end of a faucet 12. Conversely, a spout-end 14, or a coupling 90 of a water conduit 88 to which a spout-end 14 adjoins, can be made with a threading such as a female threading suited for being screwed onto a faucet having a male threading. Accordingly, various types of spout-ends 14 can be permanently, temporarily or periodically adjoined with any among a variety of standard or minimally modified faucets.

For example, in reference to the side view depictions of the low water-flow faucet and drainage system 10 embodiment shown in FIGS. 7 and 8, an attachable valve-controllable faucet 12 arrangement of the system is shown mounted by a threaded coupling 90 to a threaded end of a pipe-mounted faucet 92, wherein a mister 16 mounted to an underside portion 88 of a faucet 12 and a user-controllable valve 36 is interposed between the mister 16 and the spout-end 14 employable by a user to selectively determine a water flow rate through one or more streaming water-flow aperture(s) of the spout end, or the mister, or both. In FIGS. 7 and 8 the pipe-mounted faucet 92 is depicted being mounted by a threaded coupling 90 to an upper threaded end of a vertical pipe 94 wherein the pipe is optionally supported by a pipe vertical support member 96 to which one or more pipe mounting brackets 98 may be secured. In FIGS. 7 and 8 water-pressurized plumbing is depicted, wherein faucet valve 26 of pipe-mounted faucet 92 is in an opened position to direct a controllable flow of water into an attachable faucet arrangement comprising a coupling 90, an underside faucet portion 88 having at least one mister 16 mounted proximate to faucet spout-end 14 and a rotatable valve 36 controllable by a valve controller 28 which is interposed between the mister(s) 16 and the spout-end 14. In FIG. 7 valve controller 28 is depicted in an opened position to direct a streaming water-flow 100 through one or more streaming water-flow apertures 34 of spout-end 14, wherein the spout-end 14 is positioned so as to direct most or all of a streaming water-flow 100 into water capture and drainage apparatus 22, such as a grate (shown in cross-section in FIG. 7) or a collection of gravel, small rocks, pebbles or the like (as depicted in FIG. 8). In FIG. 8 valve controller 28 is depicted in a closed position to direct most or all of a mist-cone 18 of water (or other three-dimensionally-shaped form of mist or water micro-droplets) into water capture and drainage apparatus 22. FIG. 8 further depicts mist-cone 18 descending over a mist-emitting range 20 which is optimized dimensionally for washing and/or rinsing items i.e., being sized between a faucet 12 and water capture and drainage apparatus 22 to accommodate one or more hands, fruits, vegetables, plates, dishes, cups, bowls, pans, pots, utensils, and the like.

Optionally any streaming water-flow valve or valve controller of the system (e.g., 36 and 28 respectively) can be fitted with, or can integrally include a lock mechanism whereby the valve can be retained in a closed position, or opened position, or in one or more intermediate positions, such that an authorized individual with a key or lock combination can secure the valve or valve controller in a desired position. For example, a valve controller handle and proximate portion of the body of the valve can each include one or more lock-clasp apertures through with the clasp of a key lock or combination lock can be inserted to lock the valve to a set position or one among a choice of set positions (such as a fully or partially closed or opened valve position). Alternatively, a portion of a valve can include an internally located lock mechanism, or a lock mechanism located co-axially to the rotational axis of the valve controller, having a key aperture at an exposed end into which a matching key can be inserted and turned to lock the valve to a set position or one among a choice of set positions. In each case, one or more controllable water-conserving options or water-flow rate limits are provided. For example, in drought conditions, or in drier seasons, or any condition where water conservation is a concern, a streaming water-flow valve or valve controller of the system can be locked to a set position (such as fully or partially closed position) which conserves water in accordance with a current water management need.

In reference to FIG. 9 a cross-sectional side view depicts a removably attachable spout-end 50 equipped with a mister 16 or mister nozzle and an optional removable filter screen 48. The spout-end is further depicted having threading such as standardized male threading 52 located around an upper outer diameter end suitable for screwing the spout-end 50 into, or retro-fitting it onto, the threaded inner diameter end of a faucet, such as a faucet having a standardized female threading. While the mister 16 is depicted being made screwable into the bottom end of spout-end 50 and optionally including a screwable mister filter element 46 (such as the type that can be removed for cleaning), it is noted that a spout-end can alternatively be made having an integrally-formed mister with or without internal threading to accept a screwable mister filter element 46. Alternatively, spout-end 50 (or any of the other spout-ends described herein) can be integrally formed at the water outlet end of a faucet.

FIG. 10 is a cross-sectional side view depiction similar to FIG. 9 further comprising the spout-end 50 having a rotatable valve apertured member 40 such as the type previously described in reference to FIGS. 4A, 4B, 5A through 5D, which when rotated to a first position (as depicted in FIG. 10) prevents the emitting of a streaming water-flow from one or more streaming water-flow apertures 34 of the spout-end and directs water only through the mister 16. When rotatable valve apertured member 40 is rotated to a second position allows a streaming water-flow from the spout-end and through the mister. Optionally the valve apertured member 40 can be threaded to screw into a lower threaded end of the spout-end, and the spout-end can optionally be equipped with threading located on an upper outer diameter suitable for screwing the spout-end into the threaded inner diameter end of a faucet. Preferably, one or more gaskets, seals or O-rings 44 can be employed in a customary manner between one or more elements of any of the faucet-located valves of the present system.

In reference to FIGS. 11A and 11B, cross-sectional side views of a spout-end 50 are depicted being equipped with a mister 16 or mister nozzle having an optional removable mister filter element 46. The spout-end 50 (and any one or more of those described herein) can be permanently, periodically or temporarily adjoined to a faucet end for example by any common plumbing practice, or can be integrally formed with a faucet, or made removably-attachable by including threads such as male threads 52 on an upper end of the spout-end. As depicted in FIGS. 11A and 11B spout-end 50 is equipped with a transverse rotatable dual-valve 80 having mister-tube channel 84 and two (or one or more) valve water-streaming channels 86, wherein the transverse rotatable dual-valve 80 when rotated to a first position by a user turning valve controller 28 (as depicted in FIG. 11A) causes the mister-tube channel 84 of dual-valve 80 to be in co-axial alignment with a mister-tube 102 to direct water only through the mister 16, and positions valve water-streaming channels 86 out of registration with streaming water-flow apertures 34. The vertical downward pointing arrow of FIG. 1IA indicates the flow of water being directed through the mister-tube channel 84 into the mister-tube 102 (with the latter optionally including a mister filter element 46). Rotating the rotatable dual-valve 80 to a second position (as depicted in FIG. 11B) positions the mister-tube channel 84 out of registration with mister-tube 102 and causes the valve water-streaming channels 86 to be in co-axial alignment with the streaming water-flow apertures 34 to direct only a streaming water-flow from the spout-end. The two vertical downward pointing arrows of FIG. 11B indicate the flow of water being directed only through the water-flow apertures 34 into the streaming water-flow aperture(s) 34 of the spout-end. Optionally one or more in-between setting of the transverse rotatable dual-valve 80 (or other valves, such as those depicted in FIGS. 4B, 5A, 5B, 6A, 6B, 7, 8, 10, 12A, 12B, 13A and 13B) can provide for one or more ratios, or continually variable ratio, of the flow of water through both the streaming water aperture(s) 34 and mister 16 of the spout-end 50.

FIGS. 12A and 12B are cross-sectional side views of an optionally removably-attachable spout-end 50 similar to the spout-end depicted in FIGS. 11A and 11B, being equipped with a mister 16 or mister nozzle having an optional removable mister filter element 46. The spout-end 50 of FIGS. 12A and 12B is depicted comprising a co-axially positionable dual-seat valve 54 having a transversely mounted rotatable camshaft 58. Cam lobes 60 of camshaft 58 are rotatably operable within respective cam lobe followers 62 adjoining an upper portion of the dual-seat valve 54 and when rotated to a first position (for example by a user turning valve controller 28 as depicted in FIG. 12A) cause the cam lobe followers 62 ad dual-seat valve 54 to move to an uppermost position, wherein an annular inner valve seat 66 (see FIG. 12B) located adjacent to the upper end of a valve tube 78 of the valve is pressed against an annular valve tube seal 70 which prevents water from being directed to the mister 16 while directing a streaming water-flow through one or more streaming water-flow apertures 34 of the spout-end 50. When camshaft 58 is rotated to a second position (as depicted in FIG. 12B) the co-axially positionable dual-seat valve 54 is moved to a lowermost position wherein an annular valve gasket 56 surrounding an upper end of valve tube 78 (of valve 54) is pressed against an annular valve seat 68 which prevents directing a streaming water-flow through one or more streaming water-flow apertures 34 of the spout-end 50 while directing water to the mister 16 via valve tube 78. Preferably valve tube 78 of the dual-seat valve 54 includes an O-ring 44 co-axially operative within a central bore of the spout-end 50 to seal water directed to the mister 16 from entering into the one or more streaming water-flow apertures 34. Optionally an in-between setting of the transverse rotatable camshaft can provide for the flow of water through both the streaming water aperture(s) 34 and mister 16 of the spout-end.

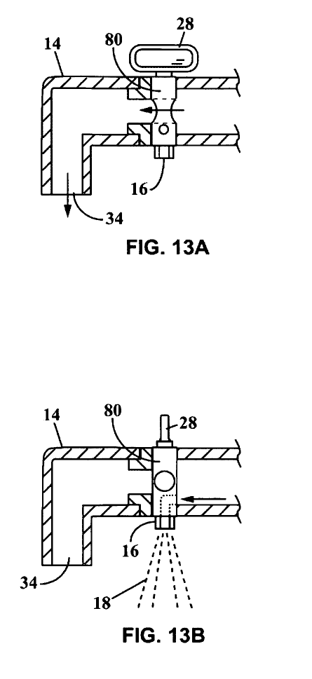

FIGS. 13A and 13B are cross-sectional side view depictions comprising a faucet arrangement comprising a water conduit 82 having a transversely mounted rotatable dual-valve and mister 104, wherein the valve/mister combination when rotated to a first position (as depicted in FIG. 13A) directs a streaming water-flow from the spout-end (in a manner similar to that of the rotatable valve described in reference to FIG. 11A). The rotatable dual-valve and mister 104 has at least one water-streaming channel 86 and at least one mister channel 106, wherein the rotatable dual-valve and mister 104 when rotated to a first position by a user turning valve controller 28 (as depicted in FIG. 13A) causes the water-streaming channel 86 of the valve to be in co-axial alignment with a spout-end water channel 108 of the spout-end adjoining water conduit 82 to direct water only through the streaming water-flow aperture(s) 34 of the spout-end. The horizontal and vertical downward pointing arrows of FIG. 13A indicate the flow of water being directed through the water-streaming channel 86. Rotating the dual-valve and mister 104 to a second position (as depicted in FIG. 13B) causes the mister channel 106 of the valve to be in co-axial alignment with the water conduit 82 a spout-end water channel 108 of the spout-end adjoining water conduit 82 to direct water only through the mister 16 located proximate to the spout-end 50.

While the present invention has been primarily described with respect to faucets and/or faucet spout-ends being equipped with one or more misters or mister nozzles having a controllably emitted three-dimensionally shaped mist which is directed through a washing and/or rinsing mist-emitting range into water capture and drainage apparatus sized and shaped to partially or totally capture waste water emitted from the faucet, it will be appreciated that the faucets and/or misters (or mister nozzles) disclosed herein may just as easily be fastened to water conduits or pipes having one or more valve controllable downward-directed misters or mister nozzles for example.

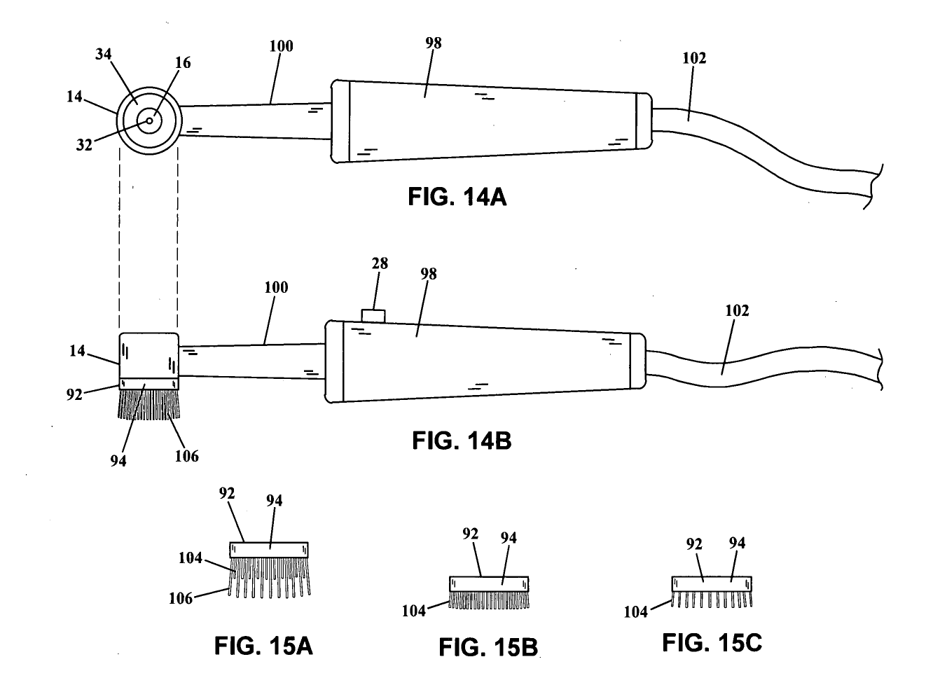

In reference to FIGS. 14A and 14B a handheld positionable dual-spout having controllable conventional-flow and mister-flow rates is depicted (in a bottom view and side view respectively) wherein, in the side view of FIG. 14B, a valve controller 28 is operatively mounted on hand-piece 98 and is configured in-line to control water coming in from flexible conduit 102 and leaving the hand-piece through conduit 100. The controllable valve (not shown) may be of a type for selectively controlling, or gradually controlling, the rate, or ratio, of water between a double-spout comprising one or more misters (a first spout-type) co-axially located within, or proximate to, a spout configured for conventional water flow-rates (a second spout-type). In FIGS. 14A and 14B an outer end of conduit 100 has an adjoining faucet spout-end 14 which is shown having a mister 16 (bottom view 14A) and a mister aperture 32 co-located within the faucet spout-end 14 such that one or more streaming water-flow apertures 34 may discharge water around the mister.

Optionally or additionally, the handheld positionable dual-spout may be configured to selectively emit one or more types of soaps or cleaning solutions, wherein the soap(s) and/or cleaning solution(s) are controllable by one or more valves selectable from any in a variety of commercially-available valves, for example one or more valve controllers may be located and made accessible to a user on a side of the hand-piece 98. Wherein a controllable flow-rate of water directed to the dual-spout can provide either negative or positive pressure employable in the discharging of a desired amount or flow rate of the soap(s) or solution(s).

In reference to FIGS. 15A through 15C each two-dimensional depiction shows a side view of a releasably-attachable spout-end scrubber element 92, each of which may optionally be fastened to a spout-end to provide a scrubbing function as desired by a user. Wherein FIG. 15A depicts a scrubber element 92 having a scrubber annular ring 94 comprising different brush bristle lengths i.e., shorter brush bristles 104, and longer brush bristles 106, FIG. 15B depicts a scrubber having shorter brush bristles 104, and FIG. 15C depicts a scrubber having different brush bristle lengths (104 and 106). It is noted that the releasable-attaching means may be any one or more among conventional fastening means (e.g. a scrubber may be screwed on or off, or may be snapped on or off, and the like). Accordingly, one or more releasably-attachable scrubbers may each be mounted on a spout-end of the apparatus to provide scrubbing functions, wherein different brush bristles lengths or density may be needed.

Although the foregoing invention has been described in some detail for purposes of clarity of understanding, it will be apparent that certain changes and modifications may be practiced within the scope of forthcoming non-provisional patent application claims.

1. A dual spout-type faucet with controllable conventional-flow and mister-flow rates, comprising: a dual spout-type faucet having a water outlet comprising one or more water misters.

2. The dual spout-type faucet of claim 1 further comprising a sink positioned beneath said one or more water misters, said sink having a basin upper opening sized and shaped to catch water emitted from said one or more water misters.

3. The dual spout-type faucet of claim 1 further comprising a drain positioned beneath said water outlet, said drain sized and shaped to catch water emitted from said one or more water misters.

4. The dual spout-type faucet of claim 1 further comprising a conduit connection to a water supply pressurized to at least 20 PSI.

5. The dual spout-type faucet of claim 1 further comprising a conduit connection to a supply of water pressurized by pressure applied by one or more portions of a human body against a water containing bladder.

6. The dual spout-type faucet of claim 1 further comprising a conduit connection to a supply of water pressurized by a hand-operated pump.

7. The dual spout-type faucet of claim 1 further comprising a conduit connection to a supply of water pressurized by a foot-operated pump.

8. The dual spout-type faucet of claim 1 further comprising a conduit connection to a supply of water pressurized by an electrically-powered pump.

9. The dual spout-type faucet of claim 1 further comprising a conduit connection to a heated water supply.

10. The dual spout-type faucet of claim 1 further comprising a conduit connection to a non-heated water supply.

11. The dual spout-type faucet of claim 1 further comprising a conduit connection to a heated water supply and a non-heated water supply.

12. The dual spout-type faucet of claim 11 further comprising at least one valve for controlling the flow of water from said heated water supply and said non-heated water supply.

13. The dual spout-type faucet of claim 1 further comprising a conduit connection to a supply of pressurized water limited to less than 10 ounces per user-cycle.

14. The dual spout-type faucet of claim 1 further comprising a soap dispenser located within reach of a user when employing said reduced water-flow faucet, and said soap dispenser having a supply of quick-rinse soap which is washable from a user's hands with.

14. A dual spout-type faucet having a water outlet comprising one or more water misters positioned proximate to an end of said water outlet and one or more valves for controlling a reduced water flow rate from said one or more misters and for controlling up to a substantially greater water flow rate from said water outlet.

15. A dual spout-type faucet having a water outlet comprising one or more water misters coaxially positioned within an end of said water outlet and one or more valves for controlling a reduced water flow rate from said one or more misters and for controlling up to a substantially greater water flow rate from said water outlet.

16. The dual spout-type faucet of claim 15 further comprising said one or more valves housed within a retrofit water outlet housing; said one or more misters coaxially positioned within an end of said retrofit water outlet housing; and, an upper end of said retrofit water outlet housing threaded for being screwed into a threaded end of a conventional faucet spout.

17. The dual spout-type faucet of claim 15 further comprising a sink positioned beneath said one or more water misters, said sink having a basin upper opening sized and shaped to catch water emitted from said one or more water misters.

18. The dual spout-type faucet of claim 15 further comprising a conduit connection to a supply of water pressurized by an electrically-powered pump.

20. The dual spout-type faucet of claim 15 further comprising a conduit connection to a heated water supply.
